(19) United States
(12) Patent Application Publication
(10) Pub. No.: US 2012/0120051 A1
(43) Pub. Date: May 17, 2012

(54) Method and system for displaying stereoscopic images

(76) Inventors: Shu-Ming Liu, Tainan County (TW); Lin-Kai Bu, Tainan County (TW)

(21) Appl. No.: 12/947,795

(22) Filed: Nov. 16, 2010

(51) Int. Cl. G06T 15/00

(52) U.S. Cl. 345/419

(57) ABSTRACT

Stereoscopic images are projected on a display device from an image source according to adaptive parameters which are adjusted according to the current positions of the projector, the screen and a user wearing a 3D viewing device. By detecting the distance between the projector and the screen and the distance between the 3D viewing device and the screen during a 3D presentation, the adaptive parameters may automatically be adjusted in order to provide the best and most comfortable 3D viewing environment. Or, the recommended values of the adaptive parameters which result in the best and most comfortable 3D viewing environment may be provided to the user for manual adjustment.

### BACKGROUND OF THE INVENTION

1. Field of the Invention

The present invention is related to a method and a system for displaying stereoscopic images, and more particularly, to a method and a system for displaying stereoscopic images according to an adaptive parameter which is adjusted according to the positions of a projector, a screen and a viewer.

2. Description of the Prior Art

Three-dimensional (3D) display technology provides more vivid visual experiences than traditional two-dimensional (2D) display technology. Stereoscopic displays are designed to provide the visual system with the horizontal disparity cue by displaying a different image to each eye. Known 3D display systems typically display a different image to each of the observers' two eyes by separating them in time, wavelength or space. There are two major types of 3D viewing environments: naked-eye and glasses-type. Naked-eye 3D display systems include using lenticular screens, barrier screens or auto-stereoscopic projection to separate the two images in space, thereby directly evoking stereoscopic effect. In glasses-type 3D display systems, 3D viewing devices are required to creating the illusion of stereoscopic images from planer images, such as using liquid crystal shutter glasses to separate the two images in time, or color filters of anaglyph glasses or polarizing glasses to separate the two images based on optical properties.

In a 3D display system which includes a separate image source (such as a projector) and a separate display device (such as a screen), the parameters for producing the best projection may vary if a user somehow relocates the image source or the display device. Meanwhile, the convergence setting which results in comfortable human perception may vary if the user moves his position during the 3D presentation. Prior art 3D display systems only allow the user to change these parameter settings according to personal preferences, and this random adjustment may not result in a comfortable viewing environment and may cause eye fatigue. As a result, there is a need for providing an adaptive 3D display system which can improve the rendering of stereo images based on the positions of the image source, the display device and the user.

### SUMMARY OF THE INVENTION

The present invention provides a 3D display system including a screen; a projective device configured to project images onto the screen according to one or more adaptive parameters; one or more sensors configured to detect one or more distances between the one or more sensors and the screen; a 3D viewing device for creating a stereoscopic effect when used in viewing images projected on the screen; and a controller, coupled to the projective device, configured to receive the one or more distances and then update the one or more adaptive parameters according to the one or more distances.

The present invention also provides a method for displaying 3D images. The methods includes projecting images onto a screen according to one or more adaptive parameters; detecting a first distance between the screen and the projective device when the images are being projected; detecting a second distance between the screen and a 3D viewing device which is configured to create a stereoscopic effect when used in viewing the images projected on the screen; and updating the one or more adaptive parameters according to at least one of the first and second distances.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 are functional block diagrams illustrating 3D display systems according to embodiments of the present invention.

FIG. 4 is a schematic diagram illustrating a 3D display system according to an embodiment of the present invention.

### DETAILED DESCRIPTION

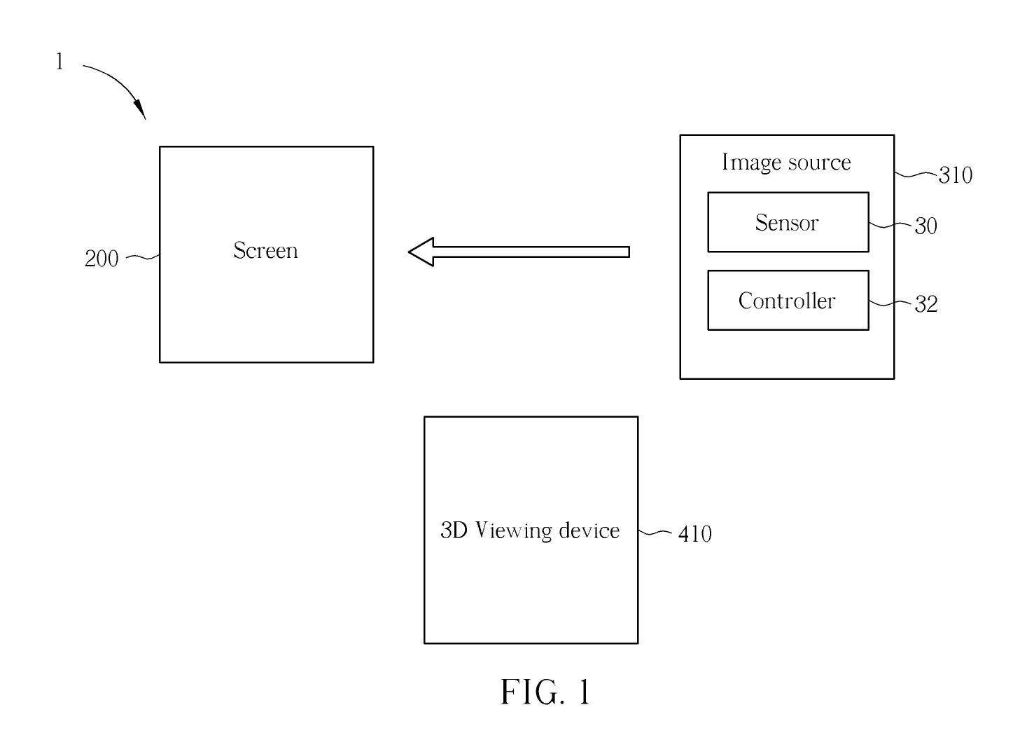

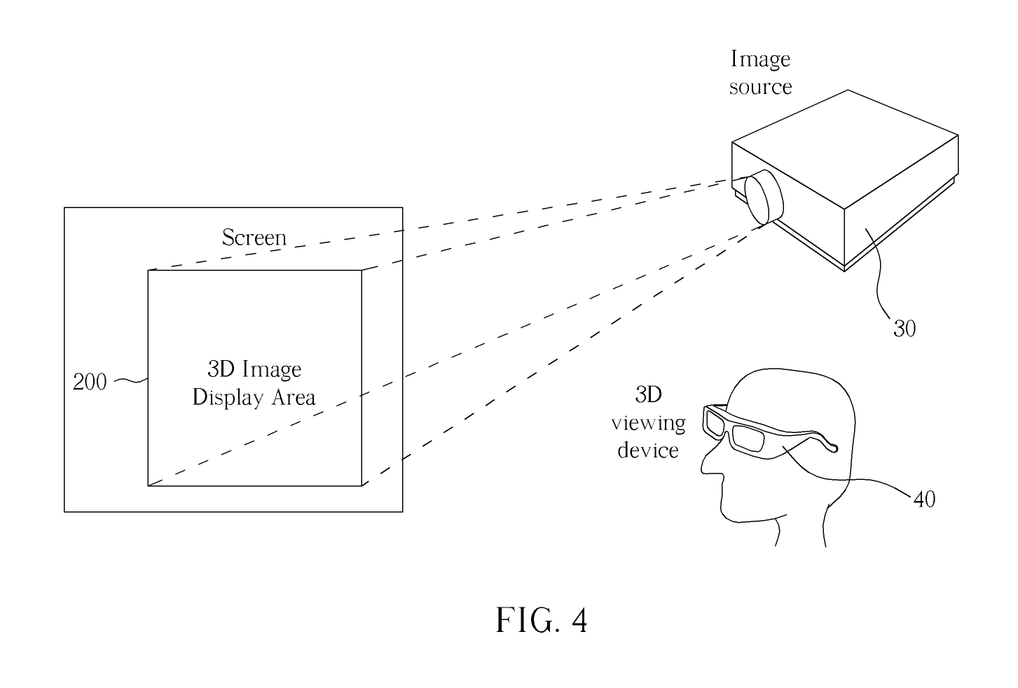

FIGS. 1-3 are functional block diagrams illustrating 3D display systems according to the embodiments of the present invention, and FIG. 4 is a corresponding schematic diagram of the present 3D display system. Referring to FIGS. 1 and 4 for a first embodiment of the present invention, a 3D display system 1 including a screen 200, an image source 310, and a 3D viewing device 410 is illustrated. The 3D viewing device 410 may be polarizing glasses, anaglyph glasses, shutter glasses or other types of glasses capable of creating a stereoscopic effect when used in viewing the images projected on the screen 200. The image source 310, which may be a projector having a sensor 30 and a controller 32, is configured to project right-eye images and left-eye images on the screen 200 according to an adaptive parameter having an initial value which has been set according to a predefined working distance between the screen 200 and the image source 310. The sensor 30 is configured to detect the actual distance between the screen 200 and the image source 310 during the 3D presentation so that the controller 32 may update the adaptive parameter accordingly.

In an application of the first embodiment, the image source 310 may project an on-screen display (OSD) message on the screen 200 showing the recommended value of the adaptive parameter based on the current positions of the screen 200 and the image source 310, thereby allowing the user to manually adjust the adaptive parameter accordingly. In another application of the first embodiment, the image source 310 may automatically adjust the adaptive parameter according to the detected distance between the screen 200 and the image source 310 using the controller 32.

The normal human visual system provides two separate views of the world through our two eyes. Each eye has a horizontal field of view of about 60 degrees on the nasal side and 90 degrees on the temporal side. A person with two eyes, not only has an overall broader field of view, but also has two slightly different images formed at the two retinas, thus forming different viewing perspectives. In normal human binocular vision, the disparity between the two views of each object is used as a cue by the human brain to derive the relative depth between objects. This derivation is accomplished by comparing the relative horizontal displacement of corresponding objects in the two images. In the first embodiment of the present invention, the mentioned adaptive parameter is the disparity cue based on which images are projected. Both applications of the first embodiment operate according to an adaptive disparity cue which is constantly updated according to the current positions of the screen 200 and the image source 310, thereby capable of providing the best viewing environment.

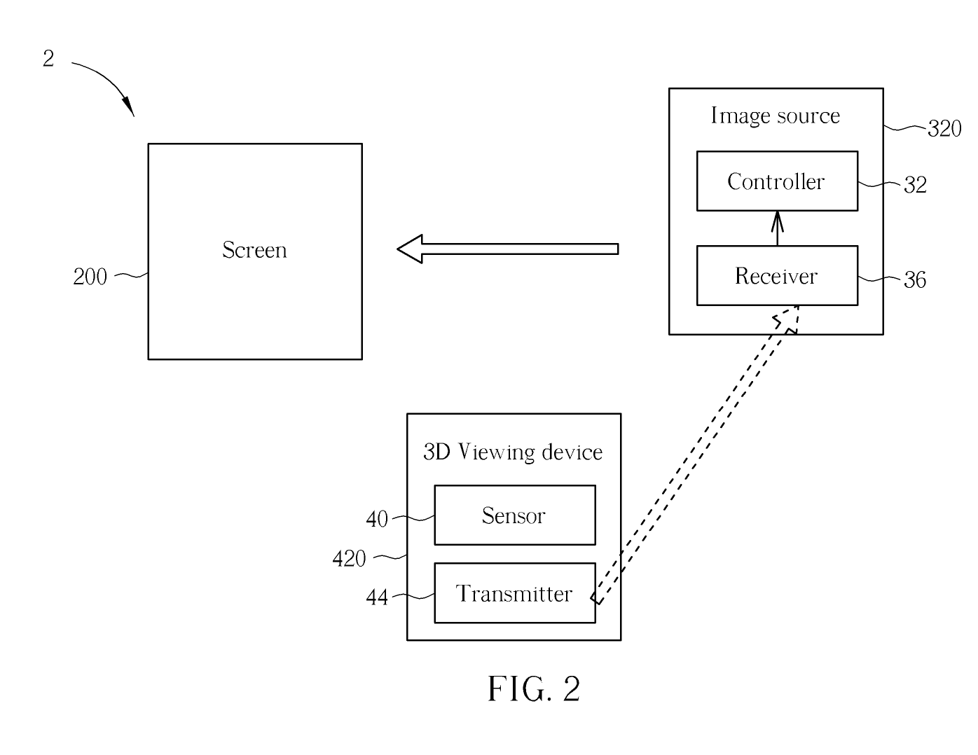

Referring to FIGS. 2 and 4 for a second embodiment of the present invention, a 3D display system 2 including a screen 200, an image source 320, and a 3D viewing device 420 is illustrated. The image source 320, which may be a projector having a controller 32 and a receiver 36, is configured to project right-eye images and left-eye images on the screen 200 according to an adaptive parameter having an initial value which has been set according to a predefined working distance between the screen 200 and the 3D viewing device 420. The 3D viewing device 420 may be polarizing glasses, anaglyph glasses, shutter glasses or other types of glasses capable of creating a stereoscopic effect when used in viewing the images projected on the screen 200. Also, the 3D viewing device 420 is configured to detect the actual distance between the user wearing the 3D viewing device 420 and the screen 200 using a sensor 40 so that the adaptive parameter may be adjusted accordingly.

The information of the detected actual distance is transmitted using a transmitter 44 of the 3D viewing device 420 and received by the receiver 36 of the image source 320, as depicted by the dotted arrow in FIG. 2. In an application of the second embodiment, the image source 320 may project an OSD message on the screen 200 showing the recommended value of the adaptive parameter based on the current positions of the screen 200 and the 3D viewing device 420, thereby allowing the user to manually adjust the adaptive parameter accordingly. In another application of the second embodiment, the image source 320 may automatically adjust the adaptive parameter according to the detected distance between the screen 200 and the 3D viewing device 420 using the controller 32.

In ophthalmology, convergence is the simultaneous inward movement of both eyes toward each other which is mediated by the medial rectus muscle, usually in an effort to maintain single binocular vision when viewing an object. Accommodation is the process by which the vertebrate eye changes optical power to maintain a clear image (focus) on an object as its distance changes. Accommodation and convergence allow us to see objects clearly both near and far without diplopia (double vision). Under the assumption of emmetropia, the normal condition of perfect vision in which parallel light rays are focused on the retina without the need for accommodation, the effort of convergence is related to the distance between the eyes and the object. In the second embodiment of the present invention, the mentioned adaptive parameter is the convergence setting based on which images are projected. Both applications of the second embodiment operate according to an adaptive convergence which is constantly updated according to the current positions of the screen 200 and the 3D viewing device 420, thereby capable of providing the most comfortable viewing environment.

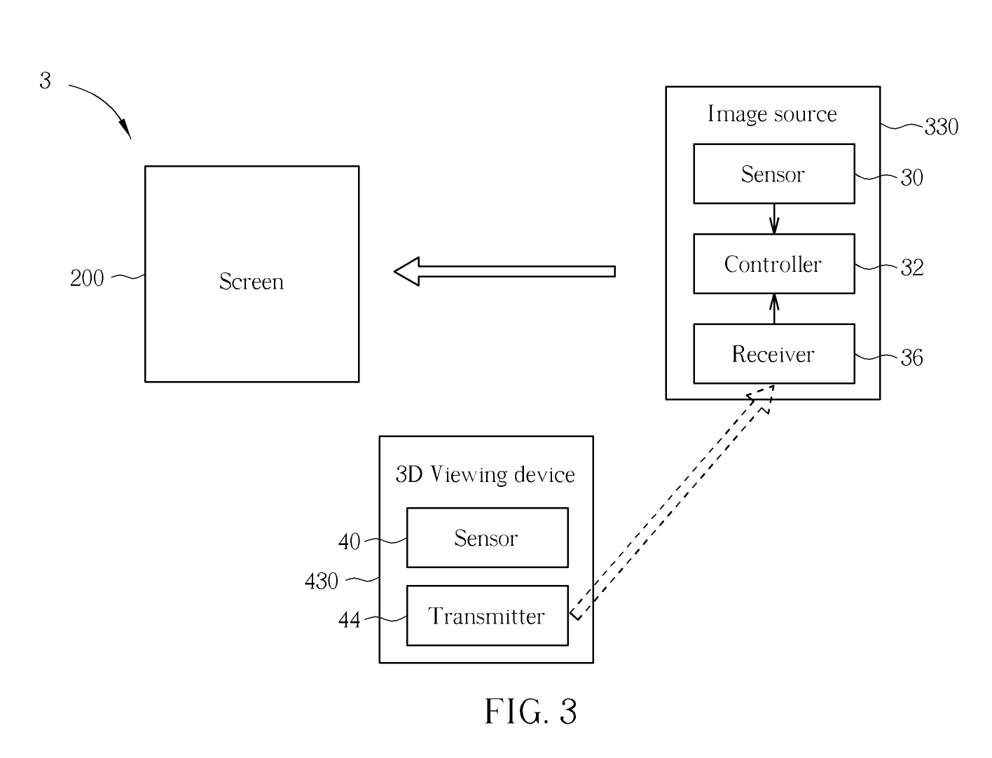

Referring to FIGS. 3 and 4 for a third embodiment of the present invention, a 3D display system 3 including a screen 200, an image source 330, and a 3D viewing device 430 is illustrated. The image source 330, which may be a projector having a sensor 30, a controller 32, and a receiver 36, is configured to project right-eye images and left-eye images on the screen 200 according to adaptive parameters having initial values which have been set according to a predefined working distance between the screen 200 and the image source 330 and a predefined working distance between the screen 200 and the 3D viewing device 430. The 3D viewing device 430 having a sensor 40 and a transmitter 44 may be polarizing glasses, anaglyph glasses, shutter glasses or other types of glasses capable of creating a stereoscopic effect when used in viewing the images projected on the screen 200. The sensor 30 of the image source 330 is configured to detect the actual distance between the screen 200 and the image source 330, while the sensor 40 of the 3D viewing device 430 is configured to detect the actual distance between the user wearing the 3D viewing device 430 and the screen 200 during the 3D presentation so that the adaptive parameters may be updated accordingly.

The information of the actual detected distances is transmitted using the transmitter 44 of the 3D viewing device 420 and received by the receiver 36 of the image source 320, as depicted by the dotted arrow in FIG. 3. In an application of the third embodiment, the image source 310 may project an OSD message on the screen 200 showing the recommended value of the adaptive parameters based on the current positions of the screen 200, the image source 330 and the 3D viewing device 430, thereby allowing the user to manually adjust the adaptive parameters accordingly. In another application of the third embodiment, the image source 330 may automatically adjust the adaptive parameters according to the current positions of the screen 200, the image source 330 and the 3D viewing device 430 using the controller 32.

In the third embodiment of the present invention, the mentioned adaptive parameters include the disparity cue and the convergence setting based on which images are projected. Both applications of the third embodiment operate according to an adaptive disparity cue and an adaptive convergence which are constantly updated according to the current positions of the screen 200, the image source 330 and the 3D viewing device 430, thereby capable of providing the best viewing environment.

In the present invention, the sensor 30 of the image source 310, 320 or 330 may be infrared (IP) sensor capable of measuring IR light radiating from the screen 200 in its field of view, thereby determining the distance between the screen 200 and the image source 310, 320 or 330. The sensor 40 of the 3D viewing device 420 or 430 may be a wireless sensor with motion sensing capability, such as one used in Wii console, thereby determining the distance between the screen 200 and the 3D viewing device 420 or 430.

In the present invention, stereoscopic images are projected according to adaptive parameters which are adjusted according to the current positions of an image source, a screen and a user wearing a 3D viewing device. By detecting the distance between the image source and the screen and the distance between the 3D viewing device and the screen during a 3D presentation, the present 3D display system may automatically adjust the adaptive parameters or provide the user with the recommended values of the adaptive parameters which result in the best and most comfortable 3D viewing environment.

Those skilled in the art will readily observe that numerous modifications and alterations of the device and method may be made while retaining the teachings of the invention.

What is claimed is:

1. A three-dimensional (3D) display system, comprising:
a screen;
a projective device configured to project images onto the screen according to one or more adaptive parameters;
one or more sensors configured to detect one or more distances between the one or more sensors and the screen;
a 3D viewing device for creating a stereoscopic effect when used in viewing images projected on the screen; and
a controller, coupled to the projective device, configured to receive the one or more distances and then update the one or more adaptive parameters according to the one or more distances.

2. The 3D display system of claim 1, wherein the controller is configured to update an adaptive disparity cue according to the one or more distances, if the one or more sensor are intergraded in the projective device.

3. The 3D display system of claim 1, wherein the controller is configured to update an adaptive convergence setting according to the one or more distances, if the one or more sensors are intergraded in the 3D viewing device.

4. The 3D display system of claim 3, wherein:
the 3D viewing device further includes a transmitter for sending information of the one or more distances; and
the controller further includes a receiver for receiving the information of the one or more distances and then updates the adaptive convergence setting accordingly.

5. The 3D display system of claim 1, wherein the one or more sensors are integrated in the 3D viewing device and the projective device respectively and configured to detect the one or more distances between the one or more sensors and the screen, and the controller is configured to receive the one or more distances and then update an adaptive disparity cue and a convergence setting accordingly.

6. The 3D display system of claim 1, wherein the updated adaptive parameter is shown on an on-screen display (OSD).

7. The 3D display system of claim 1, wherein the sensor is an infrared (IR) sensor or a wireless sensor.

8. A method for displaying 3D images, comprising:
projecting images onto a screen according to one or more adaptive parameters;
detecting a first distance between the screen and the projective device when the images are being projected;
detecting a second distance between the screen and a 3D viewing device which is configured to create a stereoscopic effect when used in viewing the images projected on the screen; and
updating the one or more adaptive parameters according to at least one of the first and second distances.

9. The method of claim 8, wherein an adaptive disparity cue, which is one of the one or more adaptive parameters, is updated according to the first distance.

10. The method of claim 8, wherein an adaptive convergence setting, which is one of the one or more adaptive parameters, is updated according to the second distance.
